(19) United States
(12) Patent Application Publication
(10) Pub. No.: US 2009/0316998 A1
(43) Pub. Date: Dec. 24, 2009

(54) OUTLINING METHOD FOR PROPERLY REPRESENTING CURVED LINE AND STRAIGHT LINE, AND IMAGE COMPRESSION METHOD USING THE SAME

(75) Inventors: Yoshiaki Hirooka, Kawanishi-shi (JP); Koji Usui, Kobe-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/488,154

(22) Filed: Jun. 19, 2009

(30) Foreign Application Priority Data
Jun. 20, 2008 (JP) 2008-161880

(51) Int. Cl. G06K 9/46

(52) U.S. Cl. 382/202

(57) ABSTRACT

A contour pixel is extracted from binarized image data. The contour of the image data is approximated to a straight line based on the extracted contour pixel. It is determined whether a first straight line in the contour obtained by the straight-line approximation includes a portion to be kept straight in the curved-line approximation, based on the relationship between the first straight line and a second straight line connected to the first straight line. In a case where it is determined that the first straight line includes a portion to be kept straight, curved-line approximation is performed by setting a control point on the first straight line at a position closer to an end of the first straight line connected to the second straight line with respect to a midpoint of the first straight line.

This application is based on Japanese Patent Application No. 2008-161880 filed with the Japan Patent Office on Jun. 20, 2008, the entire content of which is hereby incorporated by reference.

### BACKGROUND OF THE INVENTION

1. Field of the Invention

The present invention relates to an outlining method, and particularly to an outlining method for properly representing a curved line and a straight line, and an image compression method using the same.

2. Description of the Related Art

A variety of techniques for outlining a character portion included in the image data have been conventionally proposed.

For example, Document 1 (Japanese Laid-Open Patent Publication No. 2006-253892) discloses a technique for outlining the binarized image data. In this document, rough trace data consisting of a horizontal vector and a vertical vector is first extracted from the raster image data, and an anchor point is extracted from the rough trace data. The line segments located between the anchor points in a plurality of line segments forming the rough trace data are then approximated to a straight line or a curved line, and the remaining line segments are replaced by a cubic curve or a quadratic curve. Correction is subsequently made for implementing outlining.

Furthermore, in Document 1, the resolution of the binarized image used for outlining is adjusted in accordance with the size of the character.

The technique concerning the conventional outlining method has been developed for the purpose of drawing a smooth curved line. This results in an improvement in the smoothness of the curved line in the image of the outlined character while causing a part of the straight line in the original image to be modified to a curved line. This will be hereinafter specifically described with reference to FIGS. 18A to 20B.

FIG. 18A shows a binarized image before outlined which is obtained by scanning the document and the like. FIG. 18B shows an image obtained after outlining the image in FIG. 18A by the conventional method.

Referring to FIG. 18B, in the area at the upper right edge of the character “B” where the horizontal straight line is in contact with the curved line (the area surrounded by a dashed line), the straight line starts to curve at the point closer to the left side with respect to the point at which the line should have curved, that is, before the point at which the line should have curved, as compared to the binalized image in FIG. 18A.

FIG. 19A shows a binalized image before outlined, and FIG. 19B shows an image obtained after outlining the image shown in FIG. 19A by the conventional method.

Referring to FIG. 19B, in the area at the lower left edge of the character “u” where the vertical straight line is in contact with the curved line (the area surrounded by a dashed line), the straight line starts to curve at the point closer to the upper side with respect to the point at which the line should have curved, that is, before the point at which the line should have curved, as compared to the binalized image in FIG. 19A.

FIG. 20A shows a binalized image before outlined, and FIG. 20B shows an image obtained after outlining the image shown in FIG. 20A by the conventional method.

Referring to FIG. 20B, in the area at the lower left edge of the character “Z” where the straight line extending in the diagonally lower left direction is in contact with the curved line (the area surrounded by a dashed line), the lines that should be kept straight and connected to each other are approximated to a curved line for representation, as compared to the binalized image in FIG. 20A.

As described above, the conventional related art renders it difficult to draw a smooth curved line and to maintain the sharpness of the straight line portion where the straight line comes into contact with the curved line.

### SUMMARY OF THE INVENTION

The present invention has been made in light of the above-described issues and an object of the present invention is to generate an outline image by an image processing apparatus in which a curved line can be smoothly drawn and the portion that should be linearly drawn can be represented as a straight line.

An outlining method of outlining an image data stored in an outlining apparatus according to the present invention includes the steps of extracting a contour pixel from binarized image data; performing straight-line approximation for a contour of the image data based on the extracted contour pixel; determining whether a first straight line in the contour obtained by the straight-line approximation includes a portion to be kept straight in curved-line approximation, based on the relationship between the first straight line and a second straight line connected to the first straight line; and, in a case where it is determined that the first straight line includes a portion to be kept straight, performing curved-line approximation by setting a control point at a position on the first straight line closer to an end of the first straight line connected to the second straight line with respect to a midpoint of the first straight line.

An image compression method according to the present invention includes the step of compressing image data including image data outlined by the above-described outlining method.

An outlining apparatus according to the present invention includes an extraction unit configured to extract a contour pixel from binarized image data; a first approximation unit configured to perform straight-line approximation for a contour of the image data based on the contour pixel; a determination unit configured to determine whether a first straight line in the contour obtained by the straight-line approximation includes a portion to be kept straight in curved-line approximation, based on a relationship between the first straight line and a second straight line connected to the first straight line; and a second approximation unit configured to, in a case where it is determined that the first straight line includes a portion to be kept straight, perform curved-line approximation by setting a control point at a position closer to an end of the first straight line connected to the second straight line with respect to a midpoint of the first straight line.

An image compression apparatus according to the present invention includes an extraction unit configured to extract a contour pixel from binarized image data; a first approximation unit configured to perform straight-line approximation for a contour of the image data based on the contour pixel; a determination unit configured to determine whether a first straight line in the contour obtained by the straight-line approximation includes a portion to be kept straight in curved-line approximation, based on a relationship between the first straight line and a second straight line connected to the first straight line; a second approximation unit configured to, in a case where it is determined that the first straight line includes a portion to be kept straight, perform curved-line approximation by setting a control point at a position closer to an end of the first straight line connected to the second straight line with respect to a midpoint of the first straight line; and a compression unit configured to compress image data including the image data outlined by the first approximation unit and the second approximation unit.

A recording medium according to the present invention stores a computer-readable outlining program which causes an image processing apparatus to generate outline data from image data. The program causes the image processing apparatus to perform the steps of: extracting a contour pixel from binarized image data; performing straight-line approximation for a contour of the image data based on the contour pixel; determining whether a first straight line in the contour obtained by the straight-line approximation includes a portion to be kept straight in curved-line approximation, based on a relationship between the first straight line and a second straight line connected to the first straight line; and, in a case where it is determined that the first straight line includes a portion to be kept straight, performing curved-line approximation by setting a control point at a position closer to an end of the first straight line connected to the second straight line with respect to a midpoint of the first straight line.

According to the present invention, in the outlining process for the image, when a portion of the contour approximated to a straight-line vector is replaced by a portion approximated to a curved-line, it is not that the control point used for curved-line approximation is set at the midpoint uniformly with respect to the straight-line vector used as a reference, but that it is determined whether the straight line includes a portion to be kept straight after the outlining process. If it is determined that the straight line includes a portion to be kept straight, the control point is set at the point other than the midpoint.

Consequently, the portion to be kept straight can be kept in a straight line in the outlining process.

Therefore, it becomes possible to generate a preferable outline image in which, as in the conventional manner, a curved line can be smoothly drawn and a portion that should be linearly drawn can be represented by a straight line.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view of an MFP (Multi Function Peripheral) which is an embodiment of an image processing apparatus of the present invention.

FIG. 2 is a diagram showing a hardware configuration of the MFP in FIG. 1.

FIG. 3 is a diagram showing a detailed configuration of an input image processing unit in FIG. 2.

FIG. 4 is a flowchart of an outline conversion process performed in the MFP in FIG. 1.

FIGS. 5A and 5B are diagrams for illustrating the manner of extraction of a contour pixel performed in the MFP in FIG. 1.

FIG. 6 is a diagram schematically showing the contour pixel extracted in the outline conversion process in FIG. 4.

FIG. 7 is a diagram showing an example of an image obtained by straight-line vector approximation in the outline conversion process in FIG. 4.

FIG. 8 is a diagram showing an example of an image obtained by curved-line vector approximation in the outline conversion process in FIG. 4.

FIG. 9 is a flowchart showing a subroutine of the curved-line vector approximation process in FIG. 4.

FIGS. 10A and 10B are diagrams for illustrating the process in FIG. 9.

FIG. 11 is a flowchart of a first modification of the curved-line vector approximation process in FIG. 9.

FIGS. 12A to 12C are diagrams for illustrating the process in FIG. 11.

FIG. 13 is a diagram for illustrating the process in FIG. 11.

FIGS. 14A to 14C are diagrams each showing an example of outline data generated by the MFP in FIG. 1.

FIG. 15 is a flowchart of a second modification of the curved-line vector approximation process in FIG. 9.

FIGS. 16A to 16D are diagrams for illustrating a manner of setting a control point in the curved-line vector approximation process performed in the MFP in FIG. 1.

FIGS. 17A to 17D are diagrams for illustrating a manner of setting a control point in the curved-line vector approximation process performed in the MFP in FIG. 1.

FIGS. 18A and 18B are diagrams each showing an example of the outlined image generated in the conventional image processing apparatus.

FIGS. 19A and 19B are diagrams each showing an example of the outlined image generated in the conventional image processing apparatus.

FIGS. 20A and 20B are diagrams each showing an example of the outlined image generated in the conventional image processing apparatus.

### DESCRIPTION OF THE PREFERRED EMBODIMENTS

The embodiments of an image processing apparatus according to the present invention will be hereinafter described with reference to the accompanying drawings.

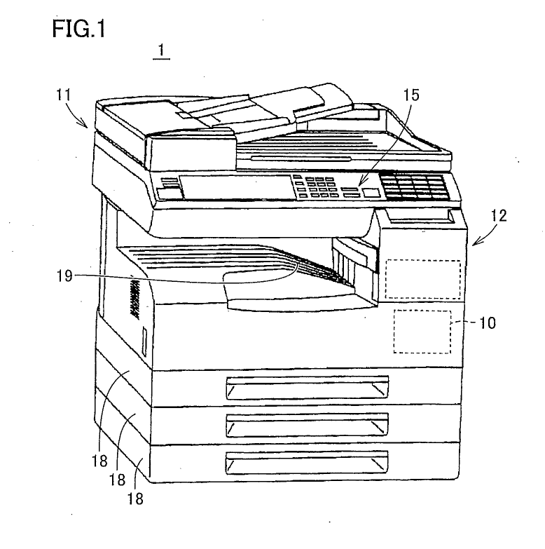

FIG. 1 is an external view of an MFP 1 which is an embodiment of an image processing apparatus of the present invention.

MFP 1 includes an operation panel 15 receiving an operation instruction for each of various processes and input of the data including characters and numerals. Operation panel 15 is provided with a plurality of keys such as a power key operated by the user.

MFP 1 also includes a scanner 11 photoelectrically reading a document to obtain image data; a printer (printing engine) 12 printing an image on the recording sheet based on the image data; a paper feeding unit 18 feeding the recording sheet to printer 12; a tray 19 onto which the recording sheet having an image printed thereon by printer 12 is ejected; and a control unit 10 housing a CPU (central processing unit) 10A and the like described below.

Scanner 11 photoelectrically reads the image information such as photos, characters and pictures from the document to obtain image data. The obtained image data is processed as appropriate, and then utilized as data for a file attached to an e-mail message which is transmitted via a network, or transmitted to other equipment over the telephone line or the like, or transmitted to printer 12 to be used for printing.

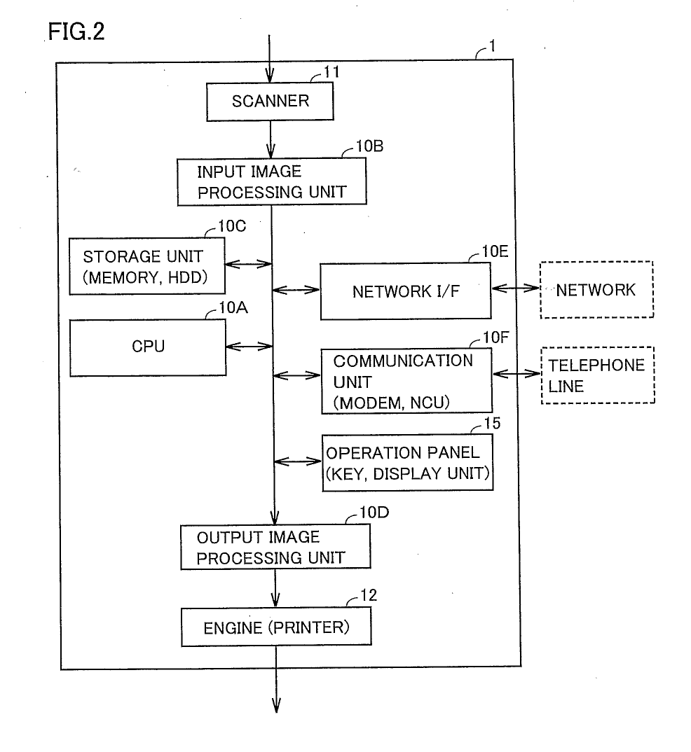

Referring to FIG. 2, in addition to the above-described components, MFP 1 includes an input image processing unit 10B, a storage unit 10C, a CPU 10A, a network I/F (interface) 10E, an output image processing unit 10D, and a communication unit 10F.

In MFP 1, the image data obtained by scanner 11 is transmitted to input image processing unit 10B.

Input image processing unit 10B carries out processes for the input image such as color conversion, color correction, resolution conversion, area discrimination, and the like. The data processed in input image processing unit 10B is stored in storage unit 10C. Storage unit 10C includes a memory such as a DRAM (Dynamic Random Access Memory) and a hard disk drive (HDD) provided with a hard disk which is an example of a magnetic memory. It is to be noted that, in MFP 1, input image processing unit 10B may be embodied, for example, by CPU 10A performing the program stored in storage unit 10C (or a recording medium which is attachable to and detachable from MFP 1), or may be embodied by one or more ASICs (Application Specific Integrated Circuit) mounted in MFP 1.

CPU 10A carries out processes such as overall control of MFP 1, detection of operation to the operation key (keys and the like displayed on the display unit of operation panel 15), display on operation panel 15, conversion of input data into an image file, and the like.

Network I/F 10E includes an I/F unit for transmitting e-mail and the like to a network, which performs protocol generation and the like.

Output image processing unit 10D performs screen control for improving the granularity of the photographic image, smoothing process for improving the smoothness of the edge of a character, PWM (Pulse Width Modulation) control, and the like.

Printer 12 prints the data generated in the output image processing unit on a sheet of paper.

Communication unit 10F including a modem and an NCU (Network Control Unit) performs modulation and demodulation of facsimile transmission and reception, generation of the facsimile communication protocol, connection to telephone lines, and the like.

Operation panel 15 includes an operation key and a display unit. The display unit is configured, for example, of a liquid crystal touch panel. The operation key includes, for example, a touch key displayed on the liquid crystal touch panel.

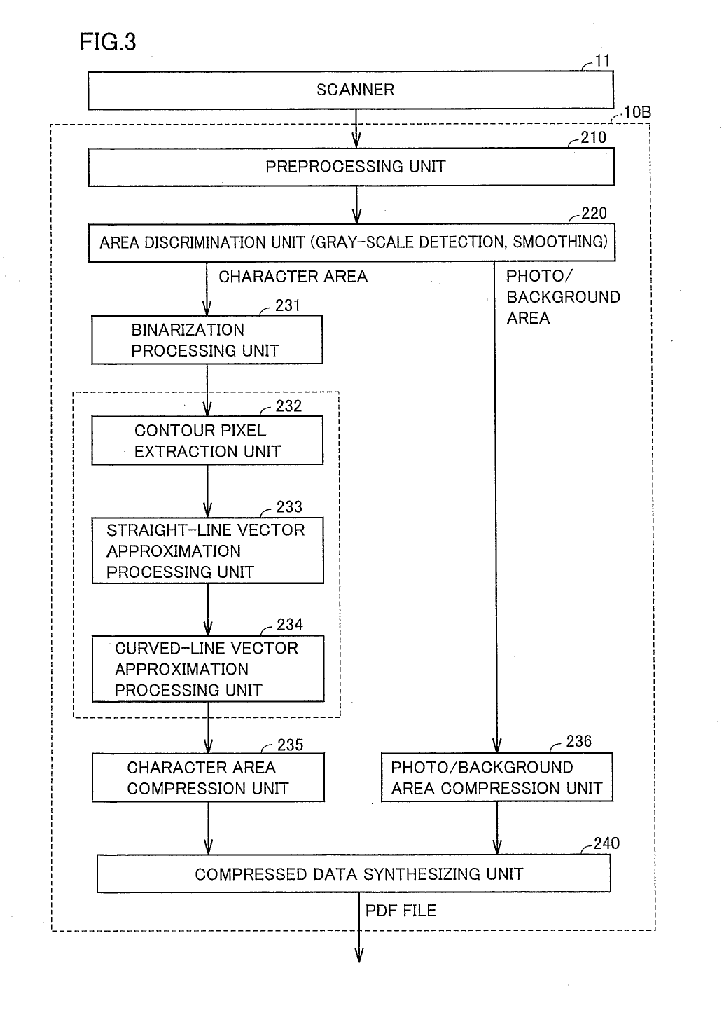

Referring to FIG. 3, input image processing unit 10B includes a preprocessing unit 210, an area discrimination unit 220, a binarization processing unit 231, a contour pixel extraction unit 232, a straight-line vector approximation processing unit 233, a curved-line vector approximation processing unit 234, a character area compression unit 235, a photo/background area compression unit 236, and a compressed data synthesizing unit 240.

When scanner 11 scans the document to generate image data, it outputs the image data to preprocessing unit 210.

In preprocessing unit 210, the image data is subjected to processes such as image format conversion, resolution conversion, processing of the base of the image, and the like. The image data subjected to these processes is transmitted to area discrimination unit 220.

In area discrimination unit 220, the image data is divided into a character area and an area including those other than a character (a photo/background area) by first performing area discrimination for a photo, a background, a character and the like.

Area discrimination unit 220 then transmits the image data of the character area to binarization processing unit 231, and also transmits the image data of the photo/background area to photo/background area compression unit 236.

With regard to the image data of the photo/background area, area discrimination unit 220 generates an 8-bit gray-scale image from the input 24-bit image data in full color, and subjects the gray-scale image to the smoothing process for eliminating noise. The resultant image is then subjected to the labeling process, to thereby detect the location of each of a plurality of photo/background areas included in the image data transmitted from preprocessing unit 210.

Binarization processing unit 231 binarizes the input image data of the character area to separate the character and the background from each other. The binarized image data is transmitted to contour pixel extraction unit 232 and subjected to the outline data conversion process performed in contour pixel extraction unit 232, straight-line vector approximation processing unit 233 and curved-line vector approximation processing unit 234.

In contour pixel extraction unit 232, the binarized character image is scanned to extract a contour pixel by pattern matching.

A pixel located in the contour portion of the image is herein referred to as a “contour pixel”.

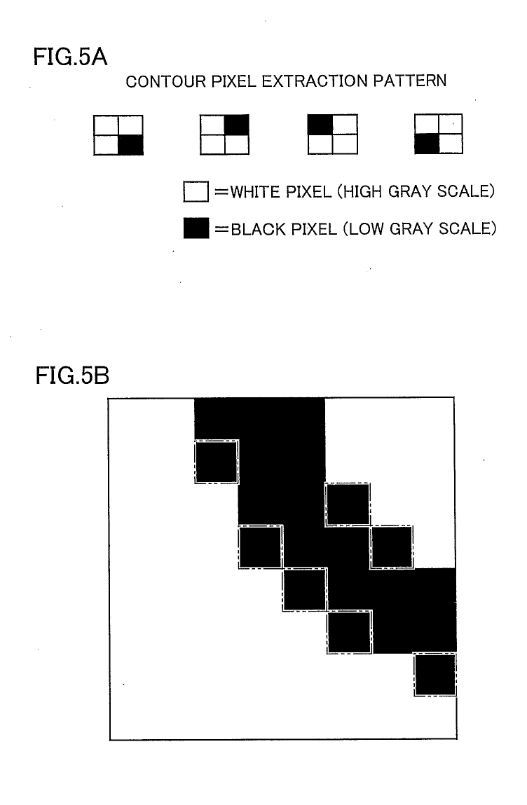

FIG. 5A shows an example of a contour pixel extraction pattern used for pattern matching. FIG. 5B shows an enlarged view of a portion of the binarized character image. The binarized character image is scanned (for example, in units of four pixels) to extract the pixel matching any of the patterns in FIG. 5A as a contour pixel. By way of example, as shown in FIG. 5B, this pattern matching allows the pixel surrounded by a chain double-dashed line to be extracted as a contour pixel.

After the contour pixel is extracted in contour pixel extraction unit 232, the image data is transmitted to straight-line vector approximation processing unit 233. In straight-line vector approximation processing unit 233, for the contour pixel extracted in contour pixel extraction unit 232, the contour pixels adjacent thereto are represented as one vector, which causes the contour of the character image to be approximated to a straight-line. The data of the character image having its contour approximated to a straight-line in straight-line vector approximation processing unit 233 is transmitted to curved-line vector approximation processing unit 234.

In curved-line vector approximation processing unit 234, a control point is set as appropriate in accordance with the conditions of the curved line, with respect to the straight-line vector of the contour of the character image generated in straight-line vector approximation processing unit 233. The contour of the character image is then approximated to a curved line based on the control point.

By way of example, MFP 1 of the present embodiment is characterized by the setting of the control point in accordance with the conditions of the curved line. It is to be noted that well-known techniques can be employed for the setting of the straight-line vector based on the contour pixel in straight-line vector approximation processing unit 233 and the curved-line approximation based on the control point in curved-line vector approximation processing unit 234, and therefore, and description thereof will not be repeated.

In character area compression unit 235, the data suitable for the character area is compressed. Furthermore, in photo/background area compression unit 236, the data suitable for the photo/background area is compressed. Since the image data of the character area serves as vector data (location information), it is considered that reversible compression method such as an Flate compression method is suitable. With regard to the photo/background area, if a reduction in file size is prioritized over maintaining of the image quality, it is considered that the irreversible compression method is suitable, such as a JPEG (Joint Photographic Experts Group) compression method in which, for example, the compression ratio is set relatively high.

Compressed data synthesizing unit 240 synthesizes the image data of the character area compressed in character area compression unit 235 and the image data of the photo/background area compressed in photo/background area compression unit 236, to generate a PDF (Portable Document Format) file and output the file to storage unit 10C.

In MFP 1, the character data and the photo data are subjected to compression suitable for characters and photos, respectively, and finally superimposed one on top of the other to form a layer and generate data in one PDF file format. This allows the image data to be converted to a file smaller in size than that compressed in a single compression method (for example, JPEG compression).

As described above, in MFP 1, the image read by scanner 11 is processed in input image processing unit 10B and thereby converted to a PDF file in which the character area and the photo/background area are compressed using different compression methods. The converted PDF file is then stored in storage unit 10C.

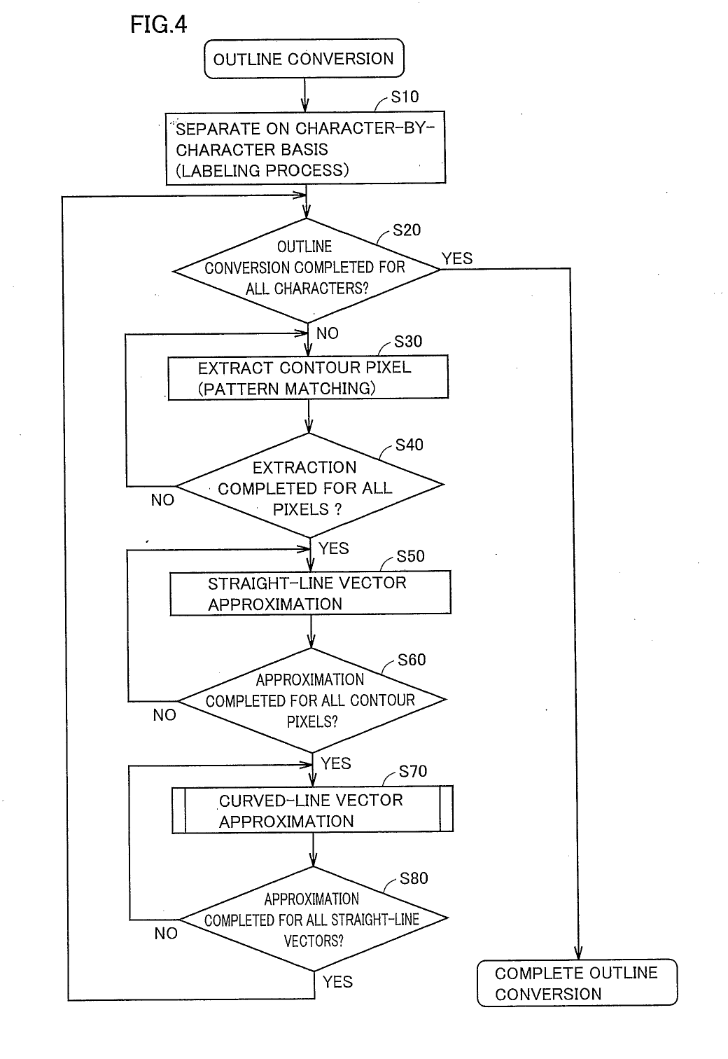

FIG. 4 is a flowchart of the process (outline conversion process) performed in contour pixel extraction unit 232, straight-line vector approximation processing unit 233 and curved-line vector approximation processing unit 234 at the time when the image data is converted to the above-described PDF file. The outline conversion process will be hereinafter described in detail.

Referring to FIG. 4, when the binarized image data is input to contour pixel extraction unit 232, then in step S10, contour pixel extraction unit 232 separates the image data of the character area on a character-by-character basis. The process then proceeds to step S20.

In step S20, contour pixel extraction unit 232 determines whether all the characters separated in step S10 have been processed in steps S30 to S80. If it is determined that all the characters have been processed, the outline conversion process is terminated. If it is determined that all the characters have not been processed, the process proceeds to step S30.

In step S30, contour pixel extraction unit 232 selects, as an object to be processed, the characters which have not been processed in steps S30 to S80 from the characters separated in step S10, and extracts a contour pixel by pattern matching from the characters to be processed. The process then proceeds to step S40.

By the process in step S30, the pixel surrounded by a chain double-dashed line in FIG. 5B is extracted as a contour pixel.

Referring back to FIG. 4, in step S40, contour pixel extraction unit 232 determines whether all the contour pixels are extracted from the characters to be processed. If it is determined that all the contour pixels are extracted, the process proceeds to step S50.

In step S50, as described above, in accordance with a predetermined algorithm straight-line vector approximation processing unit 233 performs straight-line approximation for a plurality of contour pixels extracted by contour pixel extraction unit 232. The approximated straight lines are then sequentially connected to each other to form a straight-line vector, which causes straight-line vector approximation for the contour of the character which is to be processed. The process then proceeds to step S60. It is to be noted that any known methods are applicable as a straight-line approximation algorithm.

In step S60, straight-line vector approximation processing unit 233 determines whether the straight-line vector approximation is completed for all the contour pixels extracted from the characters to be processed. If it is determined that the approximation is not completed, the process goes back to step S50, and if it is determined that the approximation is completed, the process proceeds to step S70.

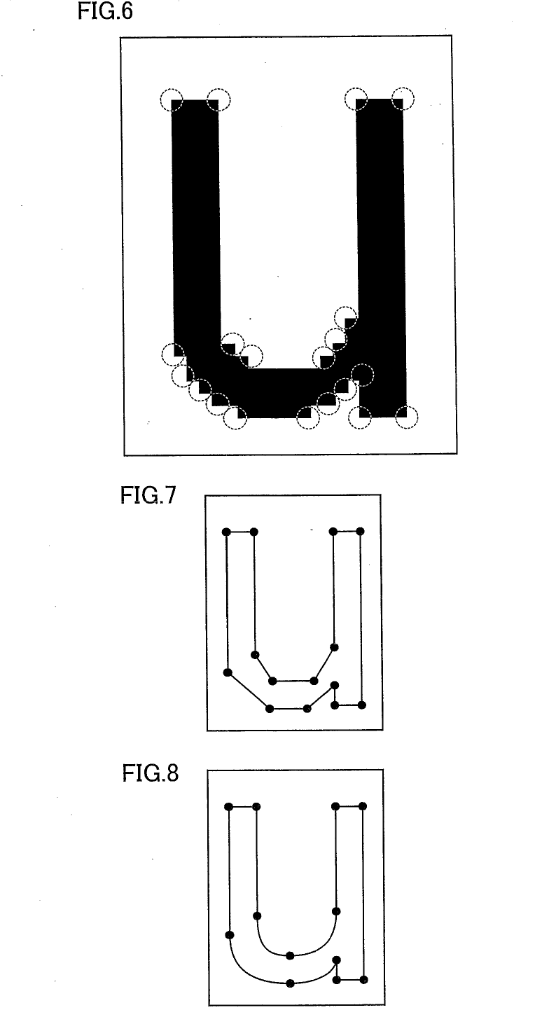

FIG. 6 is a diagram schematically showing the contour pixel, in the case where a character “u” is selected as an object to be processed, extracted from the image of the character.

FIG. 6 shows contour pixels extracted from the character image “u” which are indicated by dotted line circles. FIG. 7 shows the resultant by straight-line vector approximation for the character image based on these contour pixels.

FIG. 7 shows a state where the straight-line vectors in FIG. 4 are connected to each other by black dots.

In step S70, for the character to be processed which is approximated to a straight-line vector as shown in FIG. 7, the control point is set as appropriate on each straight-line vector and then used to perform curved-line vector approximation for the contour to be processed. Subsequently, the process proceeds to step S80.

The details of the curved-line vector approximation process in step S70 will be described later.

In step S80, curved-line vector approximation processing unit 234 determines whether the curved-line vector approximation is completed for all the straight-line vectors generated in step S50 for the character image to be processed. If it is determined that the approximation is not completed, the process goes back to step S70, and if it is determined that the approximation is completed, the process goes back to step S20.

When the curved-line vector approximation is performed for all the straight-line vectors through the process in step S70, the character image represented by the straight-line vectors shown in FIG. 7 is converted to a character image including curved lines as shown in FIG. 8.

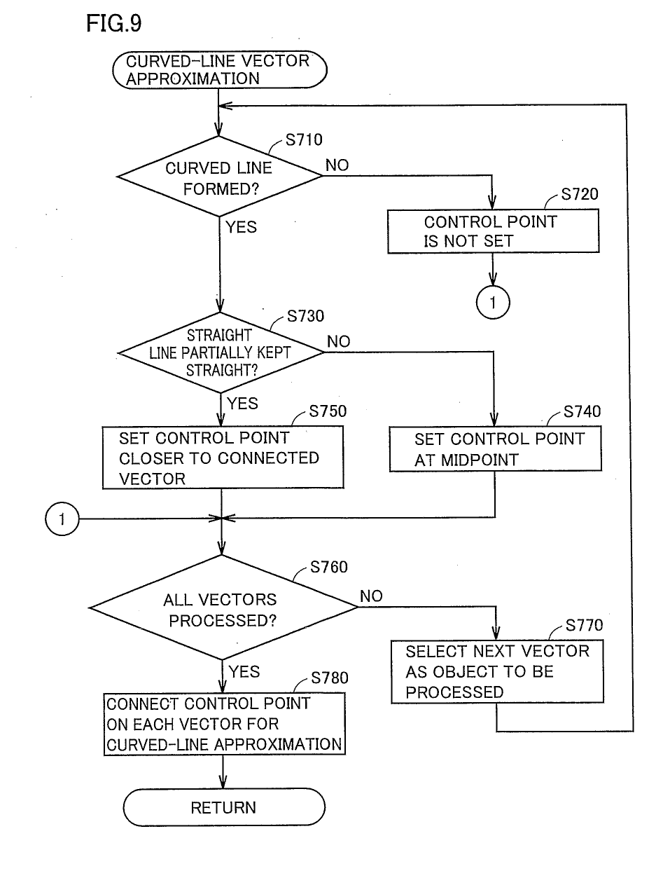

Referring to FIG. 9, the curved-line vector approximation process of step S70 in FIG. 4 will then be described.

In the curved-line vector approximation process, assuming that one of the straight-line vectors generated for the character image to be processed is taken as a vector to be processed, first in step S710, it is determined whether at least a portion of this one straight-line vector should form a curved line in the outline data. If it is determined that the portion need not form a curved line, the process proceeds to step S720, and if it is determined that the portion should form a curved line, the process proceeds to step S730.

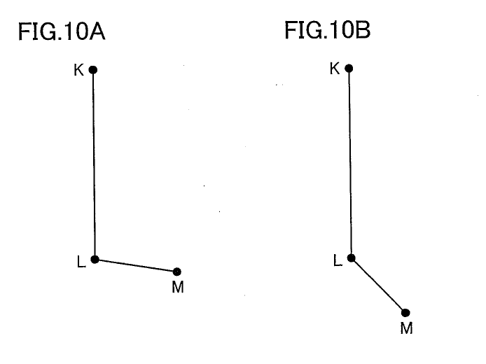

The determination in step S710 as to whether a curved line should be formed or not is made, for example, based on the determination as to whether the angle formed between the straight-line vector to be processed and another straight-line vector connected to one end of the straight-line vector to be processed is greater than a predetermined angle. The predetermined angle described herein can be assumed to be, for example, 110 degrees. The details of the determination process will then be described with reference to FIGS. 10A and 10B.

FIGS. 10A and 10B each show points K, L and M in which point K is connected to point L which is connected to point M with straight lines, respectively.

In the case where the straight-line vector to be processed is assumed to be KL, in the process of step S710, it is determined whether the angle formed between a vector KL and a vector LM is greater than a predetermined angle. It is to be noted that, in the case where the angle to be subjected to the determination process is greater than 180 degrees, this angle is assumed to be obtained by subtracting the angle formed between vectors KL and LM from 360 degrees. As understood from FIGS. 10A and 10B, it is considered that the greater the angle is formed between KL and LM, the more the curved line becomes smooth by which points K, L and M are connected in the outline data. For example, in the case where the angle formed between KL and LM exceeds 110 degrees, it is determined that, in the outline data, KL should not be represented as a straight line as shown in FIG. 10, but should be at least partially represented as a curved line. It is to be noted that the angle which is considered as criteria for determination described herein is merely an example, and may be modified as appropriate depending on the features which are desired to be included in the outline data to be generated.

Referring back to FIG. 9, in step S720, the process proceeds to step S760 without setting the control point for the straight-line vector that is to be processed.

On the other hand, in step S730, it is determined whether the straight-line vector to be processed should be at least partially kept straight in the outline data. If it is determined that the straight-line vector should be at least partially kept straight, the process proceeds to step S750, and if it is determined that the straight-line vector need not be kept straight, the process proceeds to step S740.

In step S740, the control point is set at the midpoint of the straight-line vector to be processed, and the process proceeds to step S760.

On the other hand, in step S750, the control point is set on the straight-line vector to be processed not at the midpoint thereof but at the point closer to one side with respect to the midpoint, and the process then proceeds to step S760.

The details of the determination process in step S730 will be described later.

In step S760, it is determined whether all the straight-line vectors in the characters to be processed have been processed in steps S710 to S750. If it is determined that all the straight-line vectors have not been processed, then in step S770, the next straight-line vector is selected as an object to be processed, and the process goes back to step S710.

On the other hand, if it is determined that all the straight-line vectors are processed in steps S710 to S750, the process proceeds to step S780.

In step S780, the control point set in step S740 or S750 is used to perform curved-line approximation for the character to be processed, and the process goes back to FIG. 4.

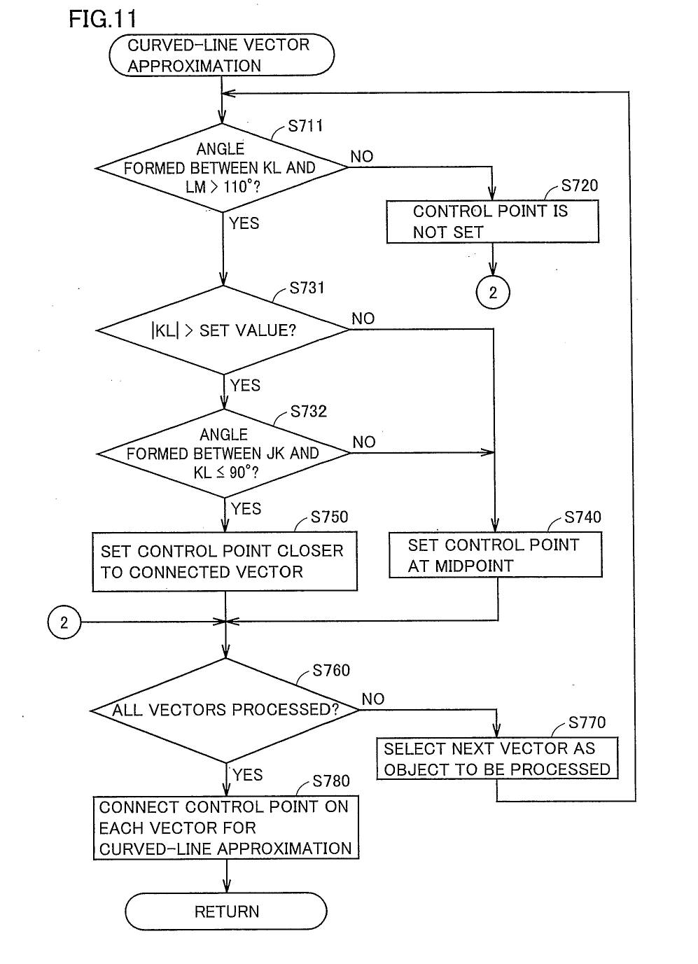

FIG. 11 is a flowchart of the modification specifically describing the processes in steps S710 and S730 with regard to the straight-line vector approximation process shown in FIG. 9.

In the curved-line vector approximation process shown in FIG. 11, step S711 is performed in place of step S710 in FIG. 9. In the process of step S711, it is determined whether the angle formed between straight-line vector KL and straight-line vector LM is greater than 110 degrees as illustrated with reference to FIGS. 10A and 10B. In this modification, if it is determined that the angle is not greater than 110 degrees, the process proceeds to step S720, and if it is determined that the angle is greater than 110 degrees, the process proceeds to step S731.

The processes of steps S731 and S732 are provided in place of that of step S730 in FIG. 9.

In step S731, it is determined whether the length of straight-line vector KL is greater than a predetermined set value. If it is determined that the length is greater than the set value, the process proceeds to step S732, and if it is determined that the length is not greater than the set value, the process proceeds to step S740.

In step S732, a determination is made as to the angle formed between straight-line vector KL to be processed and straight-line vector JK to which straight-line vector KL is connected at one end opposite to the end connected to straight-line vector LM to form an angle which is subjected to the determination process in step S711. If this angle is equal to or less than 90 degrees, the process proceeds to step S750, and it is determined that the angle is not equal to or less than 90 degrees, the process proceeds to step S740.

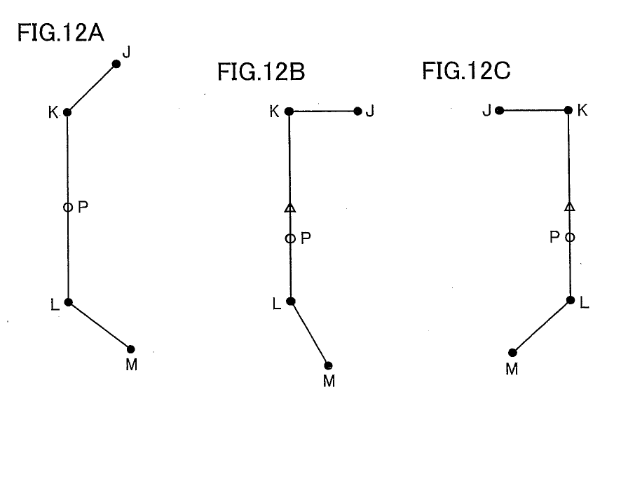

The details of the process in step S732 will then be described with reference to FIG. 12A to 12C.

FIGS. 12A to 12C each show points J, K, L, and M, in which point J is connected to point K which is connected to point L which is connected to point M each by a straight line, to form straight-line vectors, respectively. As the processes in steps S732, S740 and S750 in FIG. 11 are performed, in the case where the angle formed between JK and KL is greater than 90 degrees as shown in FIG. 12A, a control point P is set at the midpoint of straight-line vector KL (step S740). On the other hand, in the case where the angle formed between JK and KL is equal to or less than 90 degrees as shown in FIGS. 12B and 12C, control point P is set at the point on straight-line vector KL which is closer to straight-line vector LM to which straight-line vector KL is connect at one end opposite to the end connected to straight-line vector JK. FIGS. 12B and 12C each show a triangle symbol serving as a midpoint of KL.

As described above with reference to FIG. 11, it is determined whether the control point set on straight-line vector KL is located at the midpoint based on the angle formed between straight-line vector KL and the straight-line vector to which straight-line vector KL is connected at one end opposite to the end which is subjected to the determination process in step S711, or located at the point closer to one side with respect to the midpoint. Thus, as shown in FIG. 12A, it is determined that the outline data should be generated as a gentle curved line so as to pass through points J, K, L, and M, with the result that control point P is set at the midpoint of straight-line vector KL.

On the other hand, as shown in FIG. 12B or 12C, in the case where it is determined that straight-line vector KL should be kept straight at its upper portion and should be subjected to curved-line approximation at the portion joined to straight-line vector LM, control point P is set at the point closer to the end of the straight-line vector KL connected to straight-line vector LM with respect to the midpoint of straight-line vector KL.

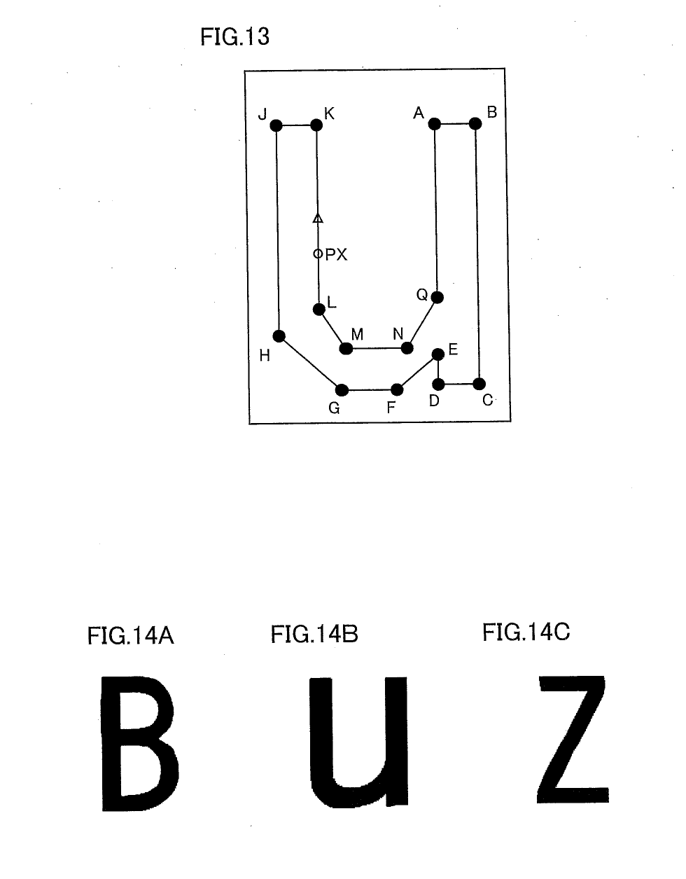

The characteristics of the processes as described with reference to FIG. 11 will then be specifically described with reference to FIG. 13. FIG. 13 is a diagram for describing the manner of setting the control point in the curved-line vector approximation process for the image having its contour approximated to a straight-line vector as shown in FIG. 7.

FIG. 13 shows a character “u” having a contour approximated to a straight line, and on the outer contour thereof, 14 points including points A, B, C, D, E, F, G, H, J, K, L, M, N, and Q are located. The setting of the control point for straight-line vectors JK and KL will then be described by way of example.

First, with regard to straight-line vector JK, the angle formed between straight-line vector JK and straight-line vector KL connected thereto is approximately 90 degrees and less than 110 degrees. Consequently, the process proceeds from step S711 to step S720 and the control point is not set on straight-line vector JK.

With regard to straight-line vector KL, assuming that an angle formed between straight-line vector KL and straight-line vector LM connected thereto is greater than 110 degrees, the process proceeds from step S711 to step S731. With regard to straight-line vector KL, the process proceeds from step S731 to step S732. In step S732, a determination is made as to the angle formed between straight-line vector JK and straight-line vector KL. In FIG. 13, the angle formed between the vectors is approximately 90 degrees. Therefore, the process proceeds to step S750.

Accordingly, with regard to straight-line vector KL, the control point is set not at the midpoint of straight-line vector KL indicated by a triangle symbol, but at the point (point PX) closer to the end of straight-line vector KL connected to straight-line vector LM to form an angle which is subjected to the determination process in step S711.

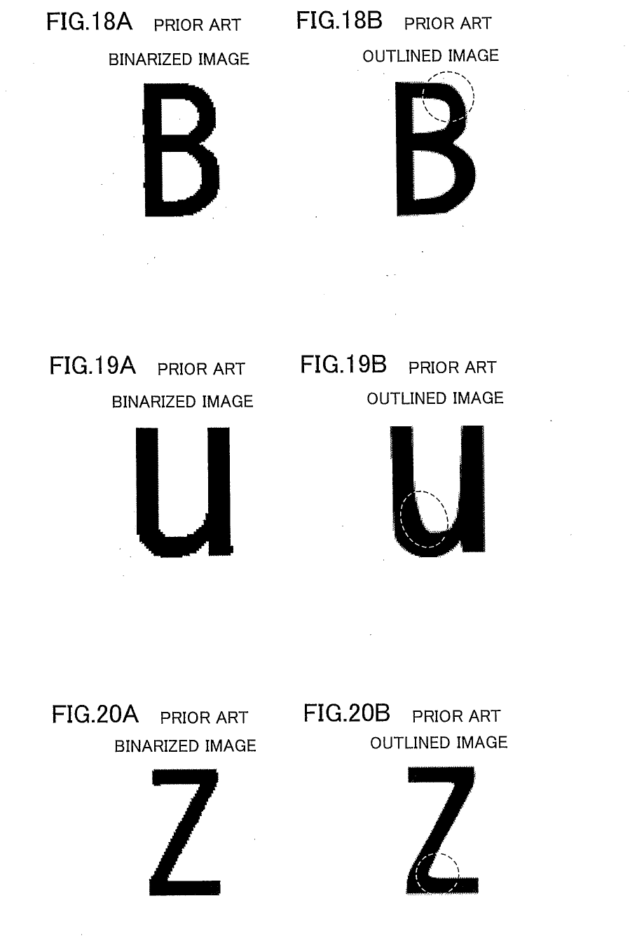

According to the present embodiments as described above, “B” shown in FIG. 18B, “u” shown in FIG. 19B and “Z” shown in FIG. 20B are represented, as shown in FIGS. 14A, 14B and 14C, respectively, without showing any undesirable bulge at the portion where the straight line and the curved line are connected to each other or the straight lines are connected to each other.

It is to be noted that the angle which is subjected to determination process in step S732 in FIG. 11 may be an angle similar to that in step S711, that is, 110 degrees. In other words, the process shown in FIG. 11 may be modified such that, if it is determined in step S732 that the angle is equal to or less than 110 degrees, the process proceeds to step S750, and if it is determined that the angle is not equal to or less than 110 degrees, the process proceeds to step S740.

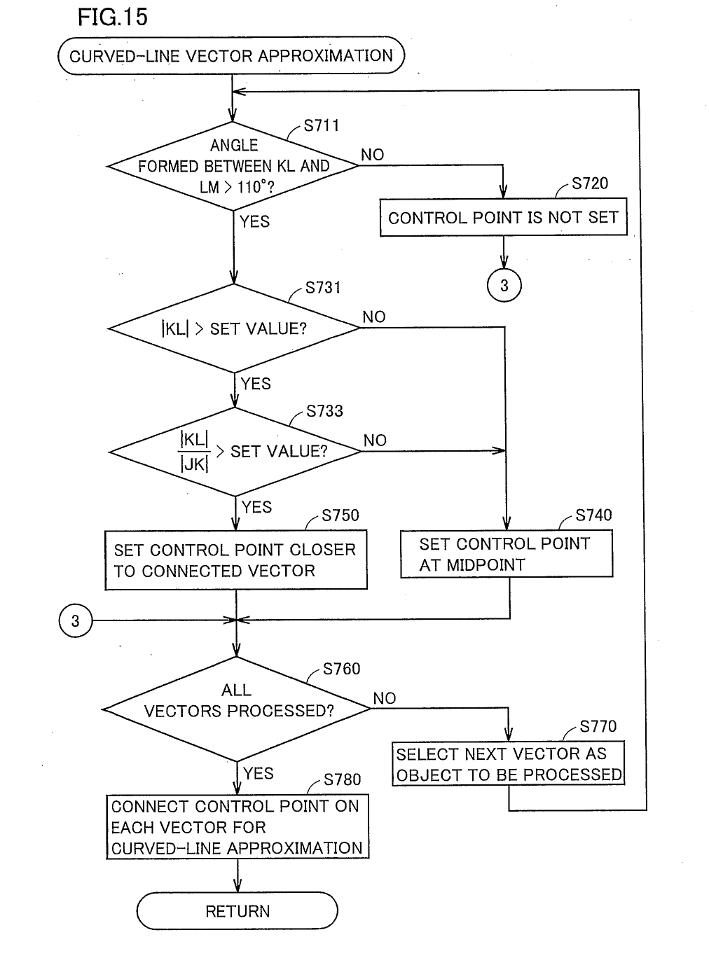

In the modification shown in FIG. 15, a process of step S733 is performed in place of that of step S732.

In step S733, it is determined whether the value obtained by dividing the length of straight-line vector KL by the length of straight-line vector JK is greater than the predetermined set value. If it is determined that the value is greater than the predetermined set value, then in step S750, as shown in FIG. 12B or 12C, the control point on straight-line vector KL is set at the point, with respect to the midpoint, closer to the end of straight-line vector KL connected to the vector (straight-line vector LM) which is different from the vector that is subjected to the determination process in step S733.

On the other hand, if it is determined that the value is not greater than the set value, the control point is set at the midpoint of straight-line vector KL in step S740.

The manner included in the idea of the present invention will then be described with regard to the setting of the control point in step S750.

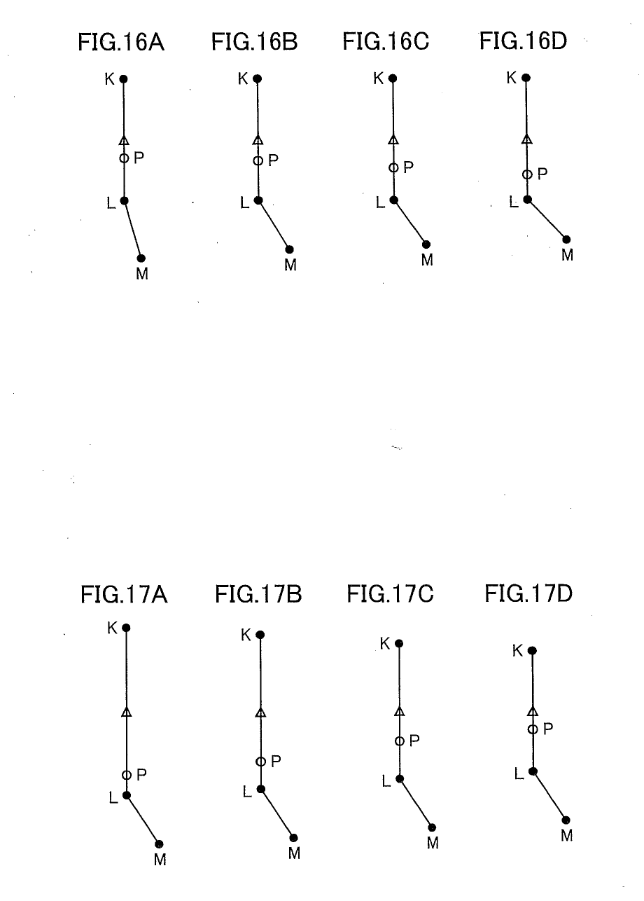

The angles formed between straight-line vectors KL and LM are shown in FIGS. 16A to 16D, which are gradually decreased in this order. It is preferable that control point P on straight-line vector KL is set to be located at the point closer to the end at which straight-line vectors KL and LM are connected to each other (at the point away from the midpoint), in accordance with a decrease in the angle formed between straight-line vectors KL and LM as shown in FIGS. 16A to 16D. This is for the purpose of generating the outline data in which a relatively large straight line portion is kept in straight-line vector KL.

In FIGS. 17A to 17D, straight-line vector KL is increased in length in this order. In the case where control point P is set on straight-line vector KL and where control point P is set at the point, with respect to the midpoint, closer to the end of straight-line vector KL connected to straight-line vector LM, it is preferable that, as shown in FIGS. 17A to 17D, the longer straight-line vector KL is, the more control point P is set close to the end of straight-line vector KL connected to straight-line vector LM (set at the point away from the midpoint). This is for the purpose of generating the outline data in the state where a relatively large straight portion is kept in straight-line vector KL.

Although, in the present embodiments as described above, the image data generated by scanner 11 is outlined, MFP 1 allows outlining of the image data other than that generated by scanner 11, such as the image data input from external devices.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An outlining method of outlining an image data stored in an outlining apparatus comprising the steps of:
extracting a contour pixel from binarized image data;
performing straight-line approximation for a contour of said image data based on said extracted contour pixel;
determining whether a first straight line in said contour obtained by said straight-line approximation includes a portion to be kept straight in curved-line approximation, based on a relationship between said first straight line and a second straight line connected to said first straight line; and,
in a case where it is determined that said first straight line includes a portion to be kept straight, performing curved-line approximation by setting a control point on said first straight line at a position closer to an end of said first straight line connected to said second straight line with respect to a midpoint of said first straight line.

2. The outlining method according to claim 1, wherein said determining step is carried out based on an angle formed between said first straight line and said second straight line.

3. The outlining method according to claim 1, wherein said determining step is carried out based on a length of said first straight line.

4. The outlining method according to claim 1, wherein said determining step is carried out based on an angle formed between said first straight line and a third straight line to which said first straight line is connected at one end opposite to an other end connected to said second straight line.

5. The outlining method according to claim 4, wherein said step of performing curved-line approximation includes the step of setting the control point at a position on said first straight line closer to said second straight line as an angle formed between said first straight line and said second straight line is decreased.

6. The outlining method according to claim 1, wherein said determining step is carried out based on a ratio between a length of said first straight line and a length of said second straight line.

7. The outlining method according to claim 6, wherein said step of performing curved-line approximation includes the step of setting the control point at a position on said first straight line closer to said second straight line as the ratio between the length of said first straight line and the length of said second straight line is increased.

8. An image compression method comprising the step of compressing image data including image data outlined by the outlining method according to claim 1.

9. An outlining apparatus comprising:
an extraction unit configured to extract a contour pixel from binarized image data;
a first approximation unit configured to perform straight-line approximation for a contour of said image data based on said contour pixel;
a determination unit configured to determine whether a first straight line in said contour obtained by said straight-line approximation includes a portion to be kept straight in curved-line approximation, based on a relationship between said first straight line and a second straight line connected to said first straight line; and,
a second approximation unit configured to, in a case where it is determined that said first straight line includes a portion to be kept straight, perform curved-line approximation by setting a control point at a position closer to an end of said first straight line connected to said second straight line with respect to a midpoint of said first straight line.

10. The outlining apparatus according to claim 9, wherein said determination unit is configured to carry out the determination based on an angle formed between said first straight line and said second straight line.

11. The outlining apparatus according to claim 9, wherein said determination unit is configured to carry out the determination based on a length of said first straight line.

12. The outlining apparatus according to claim 9, wherein said determination unit is configured to carry out the determination based on an angle formed between said first straight line and a third straight line to which said first straight line is connected at one end opposite to an other end connected to said second straight line.

13. The outlining apparatus according to claim 12, wherein said second approximation unit is configured to set the control point at a position on said first straight line closer to said second straight line as an angle formed between said first straight line and said second straight line is decreased,

14. The outlining apparatus according to claim 9, wherein said determination unit is configured to carry out the determination based on a ratio between a length of said first straight line and a length of said second straight line.

15. The outlining apparatus according to claim 14, wherein said second approximation unit is configured to set the control point at a position on said first straight line closer to said second straight line as the ratio between the length of said first straight line and the length of said second straight line is increased.

16. An image compression apparatus comprising:
an extraction unit configured to extract a contour pixel from binarized image data;
a first approximation unit configured to perform straight-line approximation for a contour of said image data based on said contour pixel;
a determination unit configured to determine whether a first straight line in said contour obtained by said straight-line approximation includes a portion to be kept straight in curved-line approximation, based on a relationship between said first straight line and a second straight line connected to said first straight line;
a second approximation unit configured to, in a case where it is determined that said first straight line includes a portion to be kept straight, perform curved-line approximation by setting a control point at a position closer to an end of said first straight line connected to said second straight line with respect to a midpoint of said first straight line; and
a compression unit configured to compress image data including image data outlined by said first approximation unit and said second approximation unit.

17. A recording medium storing a computer-readable outlining program causing an image processing apparatus to generate outline data from image data,
said program causing said image processing apparatus to perform the steps of:
extracting a contour pixel from binarized image data;
performing straight-line approximation for a contour of said image data based on said extracted contour pixel;
determining whether a first straight line in said contour obtained by said straight-line approximation includes a portion to be kept straight in curved-line approximation, based on a relationship between said first straight line and a second straight line connected to said first straight line; and
in a case where it is determined that said first straight line includes a portion to be kept straight, performing curved-line approximation by setting a control point at a position closer to an end of said first straight line connected to said second straight line with respect to a midpoint of said first straight line.
